(19) United States
(12) Patent Application Publication
(10) Pub. No.: US 2026/0278986 A1
(43) Pub. Date: Sep. 17, 2026

(54) FACILITATING USER SELECTION OF TRACKABLE OBJECTS IN VIDEO CONTENT

(71) Applicant: GoPro, Inc, San Mateo, CA (US)

(72) Inventors: Amine Belhakimi, Paris (FR); Mejed El Jabri, Le Plessis Robinson (FR); Rawia Mhiri EP Hakim, Lille (FR); Amine Chadli, San Mateo, CA (US)

(21) Appl. No.: 19/562,565

(22) Filed: Mar. 10, 2026

Related U.S. Application Data
(60) Provisional application No. 63/770,919, filed on Mar. 12, 2025.

(51) Int. Cl. G06V 10/25; G06T 7/20; G06T 7/62; G06T 7/70; G06V 10/764

(52) U.S. Cl. CPC G06V 10/25; G06T 7/20; G06T 7/62; G06T 7/70; G06V 10/764; G06V 2201/07

(57) ABSTRACT

Methods, systems, and devices for facilitating user-selection of trackable objects portrayed in a video are described. In some implementations, a system may obtain video information defining a video with a progress length, including a sequence of frames corresponding to individual moments along the progress length. The system may detect a set of one or more objects in a first frame, determine values of an apparent size parameter and a position parameter for each detected object, and define a first object search area in a second, non-adjacent frame based on the position parameter of a first object. The system may identify candidate objects in the search area, determine their apparent size parameters, and detect the first object in the second frame by matching the apparent size parameter. Responsive to this detection, the system may visually indicate the first object as a trackable object during playback of the video.

### CROSS REFERENCE TO RELATED APPLICATIONS

The present Application for Patent claims the benefit of U.S. Provisional Application No. 63/770,919, entitled “SYSTEMS AND METHODS FOR OBJECT TRACKING IN VIDEOS”, which was filed on Mar. 12, 2025, assigned to the assignee hereof, and which is hereby incorporated by reference in its entirety.

### FIELD OF TECHNOLOGY

The present disclosure relates to facilitating user selection of trackable objects in video content.

### BACKGROUND

Object tracking in video content may be utilized in video editing and playback systems, particularly for immersive formats such as spherical, hemi-spherical, panoramic, and/or other wide-angle format video. These systems may involve the detection of objects within individual frames of a video, with each frame representing a specific moment in the video's progression.

### SUMMARY

The described techniques relate to improved methods, systems, devices, and apparatuses for facilitating user selection of trackable objects in video content. Some implementations may provide a method and system for prevalidating object persistence in video content by sampling non-adjacent frames and applying filtering mechanisms to identify trackable objects. The system may begin by detecting objects in an initial frame and determining values of parameters for individual objects. Such parameters may include an apparent size parameter, a position parameter, a semantic parameter, and/or other parameters. Size filtering may be applied to exclude objects that do not meet a minimum size threshold. Semantic filtering may be used to accept objects with specific classifications, such as person, animal, or vehicle.

To assess trackability, the system may select a subsequent, non-adjacent frame based on a predefined sampling rate. The values determined for the position parameter with respect to individual objects in the first frame may be projected into the subsequent frame to define a constrained search area, within which candidate objects may be identified. The system may compare values of the apparent size parameter of the candidate objects to those of the original objects, identifying matches based on size consistency, and/or other aspects of comparison in the values of the size parameter. Objects that are successfully validated across the sampled frames may be visually indicated as trackable candidates. This approach may reduce computational load by avoiding frame-by-frame analysis and may improve user experience by presenting only persistent and reliable objects for tracking.

A method of facilitating user-selection of trackable objects portrayed in a video is described. The method may include obtaining video information defining the video, the video having a progress length. The video may include a sequence of frames portraying visual content as a function of progress through the progress length such that individual ones of the frames may correspond with individual moments along the progress length. The frames may include a first frame that may correspond to a first moment along the progress length. The method may include detecting a set of one or more objects present in the first frame. The set of one or more objects may include a first object. The method may include determining, for individual ones of the one or more objects detected in the first frame, values of an apparent size parameter and/or a position parameter, wherein the apparent size parameter may quantify apparent sizes of objects in the video and the position parameter may specify position within the visual content (e.g., Cartesian coordinates, polar coordinates, orientation definition, and/or other mechanisms for specifying position). The method may include determining, based on a value of the position parameter determined for the first object in the first frame, a first object search area in a second frame corresponding to a second moment in the progress length of the video. The second moment may be after the first moment, and the second frame may not be adjacent to the first frame in the progress length of the video. The method may include determining a first set of candidate objects present in the first object search area in the second frame. The first set of candidate objects may include a first candidate object. The method may include determining, for individual ones of the candidate objects detected in the first object search area in the second frame, values of the apparent size parameter. The method may include detecting the first object in the second frame by identifying the first candidate object as the first object in the second frame based on the values of the apparent size parameter determined for the candidate objects. The method may include, responsive to detection of the first object in the second frame, visually indicating the first object as a trackable object during playback of the video at the first moment in the progress length.

A system configured for facilitating user-selection of trackable objects portrayed in a video is described. The system may include a processor, memory coupled with the processor, and instructions stored in the memory and executable by the processor. The instructions may cause the system to obtain video information defining the video. The video may have a progress length and may include a sequence of frames portraying visual content as a function of progress through the progress length such that individual frames may correspond with individual moments along the progress length, including a first frame that may correspond to a first moment along the progress length. The system may detect a set of one or more objects present in the first frame, where the set of one or more objects may include a first object. The system may determine, for individual objects detected in the first frame, values of an apparent size parameter and a position parameter, where the apparent size parameter may quantify apparent sizes of objects in the video and the position parameter may specify position within the visual content. The system may determine, based on a value of the position parameter determined for the first object in the first frame, a first object search area in a second frame corresponding to a second moment in the progress length of the video. The second moment may be after the first moment. The second frame may not be adjacent to the first frame in the progress length of the video. The system may determine a first set of candidate objects present in the first object search area in the second frame, where the first set of candidate objects may include a first candidate object. The system may determine, for individual candidate objects detected in the first object search area in the second frame, values of the apparent size parameter. The system may detect the first object in the second frame by identifying the first candidate object as the first object in the second frame based on the values of the apparent size parameter determined for the candidate objects. The system may, responsive to detection of the first object in the second frame, visually indicate the first object as a trackable object during playback of the video at the first moment in the progress length.

A non-transitory computer-readable medium storing code for facilitating user-selection of trackable objects portrayed in a video is described. The code may include instructions executable by a processor to obtain video information defining the video, the video having a progress length. The video including a sequence of frames portraying visual content as a function of progress through the progress length such that individual ones of the frames may correspond with individual moments along the progress length, the frames including a first frame that may correspond to a first moment along the progress length. The code may include instructions executable by a processor to detect a set of one or more objects present in the first frame. The set of one or more objects may include a first object. The code may include instructions executable by a processor to determine, for individual ones of the one or more objects detected in the first frame, values of an apparent size parameter and a position parameter. The apparent size parameter may quantify apparent sizes of objects in the video and the position parameter may specify position within the visual content. The code may include instructions executable by a processor to determine, based on a value of the position parameter determined for the first object in the first frame, a first object search area in a second frame corresponding to a second moment in the progress length of the video. The second moment may be after the first moment. The second frame may not be adjacent to the first frame in the progress length of the video. The code may include instructions executable by a processor to determine a first set of candidate objects present in the first object search area in the second frame. The first set of candidate objects may include a first candidate object. The code may include instructions executable by a processor to determine, for individual ones of the candidate objects detected in the first object search area in the second frame, values of the apparent size parameter. The code may include instructions executable by a processor to detect the first object in the second frame by identifying the first candidate object as the first object in the second frame based on the values of the apparent size parameter determined for the candidate objects. The code may include instructions executable by a processor to, responsive to detection of the first object in the second frame, visually indicate the first object as a trackable object during playback of the video at the first moment in the progress length.

In some examples of the method, systems, and non-transitory computer-readable medium described herein, detecting the set of one or more objects present in the first frame may include detecting potential objects present in the first frame. Semantic classifications may be determined for the potential objects present in the first frame, such that a first semantic classification may be determined for the first object. Filtering the potential objects may be based on the semantic classifications for the potential objects such that inclusion of the first object in the set of objects present in the first frame may be based on determination of the first semantic classification for the first object.

In some examples of the method, systems, and non-transitory computer-readable medium described herein, filtering the potential objects based on the semantic classifications for the potential objects may accept the potential objects with semantic classifications of one or more of person, animal, and/or vehicle into the set of objects present in the first frame.

In some examples of the method, systems, and non-transitory computer-readable medium described herein, detecting the set of one or more objects present in the first frame may include detecting potential objects present in the first frame. Filtering the potential objects may be based on values of the apparent size parameter of the potential objects in the first frame such that inclusion of the first object in the set of objects present in the first frame may be based on the value of the apparent size parameter of the first object in the first frame satisfying a minimum size threshold.

Some examples of the method, systems, and non-transitory computer-readable medium described herein may further include operations, features, means, or instructions for, responsive to detection of the first object in the second frame, determining, based on the value of the position parameter determined for the first candidate object in the second frame, a first object search area in a third frame corresponding to a third moment in the progress length of the video. The third moment may be after the second moment, and the third frame may not be adjacent to the second frame in the progress length of the video. A second set of candidate objects may be determined to be present in the first object search area in the third frame, wherein the second set of candidate objects may include a second candidate object. Values of the apparent size parameter may be determined for individual ones of the candidate objects detected in the first object search area in the third frame. The first object may be detected in the third frame by identifying the second candidate object as the first object in the third frame based on the values of the apparent size parameter determined for the candidate objects. Visually indicating the first object as a trackable object during playback of the video at the first moment in the progress length may be further responsive to detection of the first object in the third frame.

In some examples of the method, systems, and non-transitory computer-readable medium described herein, the sequence of frames may include at least one frame corresponding to a moment in the progress length of the video prior to the first moment.

In some examples of the method, systems, and non-transitory computer-readable medium described herein, the sequence of frames may include between 10 and 45 frames that correspond to moments in the progress length of the video between the first moment and the second moment.

In some examples of the method, systems, and non-transitory computer-readable medium described herein, determining the first set of candidate objects may include detecting candidate objects present in the second frame, wherein the candidate objects may include the first candidate object. Values of the position parameter may be determined for individual ones of the candidate objects detected in the second frame. The first set of candidate objects present in the first object search area in the second frame may be determined based on the values of the position parameter determined for the candidate objects in the second frame and the first object search area in the second frame.

In some examples of the method, systems, and non-transitory computer-readable medium described herein, determining the first set of candidate objects present in the first object search area in the second frame may include comparing the values of the position parameter determined for the candidate objects in the second frame with the first object search area in the second frame.

Some examples of the method, systems, and non-transitory computer-readable medium described herein may further include operations, features, means, or instructions for receiving user input selecting the first object based on the visual indication. Responsive to said selection, a framing for the video may be determined that tracks the first object subsequent to the first moment in the progress length of the video.

In some examples of the method, systems, and non-transitory computer-readable medium described herein, the framing may specify a viewing window through which the visual content may be presented as a function of progress through the progress length of the video. The framing may specify an orientation parameter of the viewing window as a function of progress through the video to maintain the first object within the viewing window.

In some examples of the method, systems, and non-transitory computer-readable medium described herein, determining the value of the apparent size parameter for the first object in the first frame may include determining one or more dimensions of a bounding box encompassing the first object in the first frame.

In some examples of the method, systems, and non-transitory computer-readable medium described herein, determining the value of the apparent size parameter for the first object in the first frame may include determining a horizontal dimension of the bounding box.

In some examples of the method, systems, and non-transitory computer-readable medium described herein, identifying the first candidate object as the first object in the second frame may be based on the value of the apparent size parameter determined for the first candidate object in the second frame being closer to the value of the apparent size parameter determined for the first object in the first frame than the value of the apparent size parameter determined for any other candidate object in the first set of candidate objects in the second frame.

As used herein, any association (or relation, or reflection, or indication, or correspondence) involving processor(s), and/or another entity or object that interacts with any part of the system and/or plays a part in the operation of the system, may be a one-to-one association, a one-to-many association, a many-to-one association, and/or a many-to-many association, or an N-to-M association (note that N and M may be different numbers greater than 1). As used herein, the phrase “configured to” is intended to be interpreted broadly, as “being capable of or suitable for performing” some function or feature, without requiring any adaptations to provide said function or feature.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular forms of “a”, “an”, and “the” include plural referents unless the context clearly dictates otherwise.

### BRIEF DESCRIPTION OF THE DRAWINGS

FIG. 1 illustrates an example of a system for information processing configured for facilitating user selection of trackable objects in video content in accordance with aspects of the present disclosure.

FIG. 2 shows an annotated visual diagram which supports techniques for facilitating user selection of trackable objects in video content in accordance with various aspects of the present disclosure.

FIG. 3 illustrates a timeline with annotations that supports techniques for facilitating user selection of trackable objects in video content in accordance with various aspects of the present disclosure.

FIG. 4 illustrates an example of a process flow for facilitating user selection of trackable objects in video content in accordance with various aspects of the present disclosure.

FIG. 5 shows a diagram of a system including a device for facilitating user selection of trackable objects in video content in accordance with various aspects of the present disclosure.

FIG. 6 shows a flowchart illustrating a method for facilitating user selection of trackable objects in video content in accordance with various aspects of the present disclosure.

FIG. 7 shows a flowchart illustrating a method for facilitating user selection of trackable objects in video content in accordance with various aspects of the present disclosure.

### DETAILED DESCRIPTION

Methods, systems, devices, and apparatuses for facilitating user selection of trackable objects in video content are disclosed. In some examples, existing object tracking systems may face significant limitations in their ability to reliably identify and validate objects for tracking in video content. These systems may often detect and present a large number of objects in each frame, many of which may be transient, occluded, or erratic in motion. This may result in an overwhelming user interface and frequent tracking failures when unsuitable objects are selected. Additionally, the computational demands of analyzing every frame to assess object persistence may be prohibitive, particularly for high-resolution or high-frame-rate video. The lack of effective filtering mechanisms, such as size-based or semantic filtering, may further exacerbate the problem by failing to exclude objects that are unlikely to be trackable. These challenges may highlight the need for a more efficient and reliable method to prevalidate object persistence and ensure that only suitable objects are presented as trackable candidates.

In some implementations, a system may process video data that defines a video with a specific duration, referred to as the progress length. The video may consist of a sequence of individual frames, where each frame may correspond to a specific moment along the progress length. These frames may be analyzed individually to detect objects and determine their characteristics. The system may begin by analyzing a first frame of the video, which may correspond to a first moment in the progress length. Within this frame, the system may detect one or more objects present in the visual content, and these detected objects may undergo processing to determine their suitability for further analysis.

To refine the detected objects, some implementations may apply semantic filtering, which may involve classifying the objects into predefined categories such as “person,” “animal,” or “vehicle.” Objects that may not match these classifications may be excluded from further consideration. Additionally, the system may apply size filtering to the detected objects, which may involve determining a value that quantifies the size of each object, such as the dimensions of a rectangular boundary that surrounds the object. Only objects whose size value may meet or exceed a minimum threshold may be retained for further analysis. This dual filtering process may ensure that only relevant and appropriately sized objects are considered for subsequent steps.

For individual objects that pass the initial filtering process, the system may determine values for two or more specific parameters. The first parameter may quantify the size of the object, such as the dimensions of the rectangular boundary. The second parameter may specify the spatial location of the object within the visual content, such as the coordinates of the object's center or a directional reference relative to the frame. These parameters may serve as the basis for tracking the object across multiple frames. To evaluate whether an object may be suitable for tracking, the system may analyze additional frames of the video, beginning with a second frame that may correspond to a second moment in the progress length. This second frame may not be immediately adjacent to the first frame and may be separated by one or more intervening frames, with the interval determined by a sampling rate that may be lower than the video's native frame rate.

In some implementations, the system may project the spatial location of individual objects detected in the first frame into the second frame. This projection for one of the objects may define a specific region within the second frame, referred to as a search area, where the system may look for the object. By limiting the search to this region, the system may reduce the amount of data that may need to be analyzed, thereby improving computational efficiency. Within the defined search area in the second frame, the system may detect one or more candidate objects and determine a value that quantifies the size of each candidate object. The system may then compare the size value of each candidate object in the second frame to the size value of the corresponding object in the first frame. Based on this comparison, the system may identify the candidate object whose size value may most closely match the original size value or whose size difference may fall within a predetermined threshold. If such a match is identified, the system may determine that the object has persisted between the first and second frames.

To further validate the persistence of an object, the system may analyze a third frame of the video (and so on), which may correspond to a third moment in the progress length. This third frame may also be non-adjacent to the second frame, and the system may project the updated spatial location of the object from the second frame into the third frame to define a new search area. Within this new search area, the system may detect candidate objects and determine their size values. The system may compare these size values to the size value of the object in the second frame to identify a match. If the object may be successfully detected in the third frame, the system may confirm its persistence across multiple frames. This multi-frame validation process may ensure that only objects with consistent characteristics are considered suitable for tracking.

Objects that may be successfully detected and validated across the sampled frames may be visually indicated as suitable for tracking. This visual indication may be presented during playback of the video at the first moment in the progress length, allowing users to identify and select objects that may be reliably tracked. Objects that may not meet the validation criteria may not be visually indicated and may not be available for selection. Some implementations may allow a user to select one of the visually indicated objects for tracking. Upon selection, the system may determine how the video content may be displayed to maintain the selected object within view as the video progresses. This may involve defining a specific portion of the visual content, referred to as a viewing window, that may be displayed to the user. The system may determine an orientation value, such as a directional reference, that may specify how the viewing window may be adjusted over the progress length of the video to keep the selected object within view.

In some implementations, the system may manage computational resources by analyzing only non-adjacent frames rather than every frame in the video. By filtering out objects that may not persist across the sampled frames, the system may reduce the number of objects presented to the user. This process may enable the system to operate efficiently across a variety of devices and computational environments. By focusing on a subset of frames and applying rigorous filtering and validation processes, the system may balance accuracy and efficiency, ensuring that users may interact with a streamlined set of objects suitable for tracking. This approach may enhance the overall user experience while minimizing the computational demands of the system.

Aspects of the subject matter described in this disclosure can be implemented to realize one or more of the following potential advantages. The described techniques may be implemented to support improved user interaction by presenting a simplified and visually clear interface that may highlight objects deemed suitable for tracking. This approach may reduce user frustration by minimizing the likelihood of selecting objects that fail to persist across frames. The system may enhance computational efficiency by focusing processing efforts on non-adjacent frames, limiting analysis to specific search areas, and/or through other techniques, which may conserve resources and enable operation on devices with varying computational capabilities. By leveraging a multi-frame validation process, the system may ensure that objects identified as trackable exhibit consistent characteristics, which may improve the reliability of tracking outcomes. The methods described may also facilitate seamless integration into video editing workflows by providing a mechanism for dynamically adjusting the viewing window to maintain selected objects within view, which may enhance the overall quality of the user experience.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to facilitating user selection of trackable objects in video content.

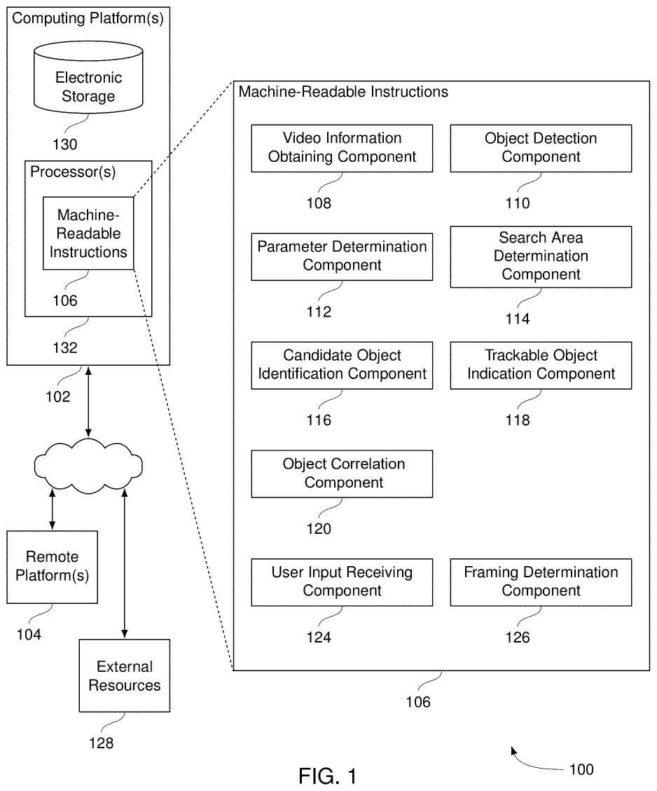

FIG. 1 illustrates an example of a system 100 for information processing configured for facilitating user selection of trackable objects in video content in accordance with aspects of the present disclosure. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction components. The instruction components may include computer program components. The instruction components may include one or more of a video information obtaining component 108, an object detection component 110, a parameter determination component 112, a search area determination component 114, a candidate object identification component 116, a trackable object indication component 118, an object correlation component 120, a user input receiving component 124, a framing determination component 126 and/or other instruction components.

The video information obtaining component 108 may be configured to obtain video information defining the video, the video having a progress length, the video including a sequence of frames portraying visual content as a function of progress through the progress length such that individual ones of the frames may correspond with individual moments along the progress length. The frames including a first frame that may correspond to a first moment along the progress length. In some implementations, the video information obtaining component 108 may access video data stored in memory, which may include RAM, flash storage, or other storage media. The video information obtaining component 108 may process video that is spherical, hemi-spherical, panoramic, and/or in some other wide angle format. In some implementations, the video information obtaining component 108 may retrieve video information from a remote server or cloud storage via a network connection.

The object detection component 110 may be configured to detect a set of one or more objects that may be present in the first frame, wherein the set of one or more objects may include a first object. In some implementations, the object detection component 110 may detect objects such as people, animals, or vehicles based on pre-determined semantic classifications. The object detection component 110 may identify objects by analyzing pixel patterns, color distributions, color gradients, texture features, and/or other parameters within the visual content of the first frame. In some implementations, the object detection component 110 may detect objects of varying sizes, including small objects that may occupy a minimal portion of the frame or larger objects that may span a significant area. In some implementations, the object detection component 110 may detect objects based on their spatial arrangement or proximity to other objects within the frame.

In some examples, the object detection component 110 may be configured to detect potential objects present in the frames, and filter the potential objects based on the semantic classifications for the potential objects such that inclusion of the first object in the set of objects present in the first frame may be based on determination of the first semantic classification for the first object. In some implementations, the object detection component 110 may detect potential objects such as people, animals, or vehicles by analyzing pixel patterns, color gradients, texture features, and/or other parameters within the visual content of the first frame. In some implementations, the object detection component 110 may determine semantic classifications by referencing a pre-trained model that may categorize objects into predefined classes based on their visual characteristics. In some implementations, the object detection component 110 may filter out potential objects that may not match any of the predefined semantic classifications, such as objects with ambiguous or unrecognizable features. In some implementations, the object detection component 110 may accept potential objects with semantic classifications that may include person, animal, or vehicle while excluding objects with classifications such as background elements or abstract shapes. In some implementations, the object detection component 110 may apply a confidence threshold to the semantic classifications, such that potential objects with low classification confidence may be excluded from the set of objects present in the first frame.

In some examples, the object detection component 110 may be configured to filter the potential objects based on the semantic classifications for the potential objects to accept the potential objects with semantic classifications of one or more of person, animal, and/or vehicle into the set of objects present in the first frame. In some implementations, the object detection component 110 may reference a database of pre-labeled object categories to match detected objects with predefined classifications. In some implementations, the object detection component 110 may apply a probabilistic model to determine the likelihood that a detected object belongs to one of the accepted classifications, such as person, animal, or vehicle. In some implementations, the object detection component 110 may incorporate contextual information from the surrounding visual content to refine the classification process, such as identifying a person based on proximity to other human-related objects like bicycles or chairs.

In some examples, the object detection component 110 may be configured to detect potential objects present in the first frame, and to filter the potential objects based on values of the apparent size parameter of the potential objects in the first frame such that inclusion of the first object in the set of objects present in the first frame may be based on the value of the apparent size parameter of the first object in the first frame satisfying a minimum size threshold. In some implementations, the object detection component 110 may determine the apparent size parameter by evaluating the pixel area occupied by the potential objects within the first frame. In some implementations, the object detection component 110 may exclude potential objects that may have dimensions below a predefined threshold, such as objects occupying fewer than a specified number of pixels. In some implementations, the object detection component 110 may accept potential objects with bounding box dimensions that may exceed a specific width or height threshold.

The parameter determination component 112 may be configured to determine, for individual ones of the objects and/or candidate objects detected, values of an apparent size parameter, a position parameter, and/or other parameters. The apparent size parameter may quantify apparent sizes of objects in the video. The position parameter may specify position within the visual content. In some implementations, the parameter determination component 112 may determine the values of the apparent size parameter by analyzing the dimensions of a bounding box that may encompass the detected object (e.g., the bounding box may be determined at detection by object detection component 110 and/or other components). The parameter determination component 112 may determine the values of the position parameter by identifying the geometric center of the bounding box, by referencing a directional vector relative to a capture reference frame, and/or by some other mechanism. In some implementations, the parameter determination component 112 may determine the values of the apparent size parameter by evaluating the pixel density or area occupied by the object within the frame. The parameter determination component 112 may determine the value position parameter by mapping the object's location to a coordinate system that may correspond to the visual content of the frame.

The search area determination component 114 may be configured to determine, based on the values of the position parameter determined for the objects, such as the first object in the first frame, object search areas in a subsequent frame corresponding to a subsequent moment in the progress length of the video (e.g., a second frame corresponding to a second moment in the progress length, a third frame subsequent to the second frame corresponding to a third moment in the progress length, and so on). The object search areas may include a first object search area for the first object in the second frame. The second moment may be after the first moment. The second frame may not be adjacent to the first frame in the progress length of the video. For example, there may be between 10 and 45 frames between the first frame and the second frame. There may be about 15 frames between the first frame and the second frame. The number of frames between the first frame and the second frame may be based on a sampling rate for the object trackability determination, and/or on some other critera. In some implementations, the search area determination component 114 may determine the first object search area by projecting the value of the position parameter for the first object in the first frame into the coordinate space of the second frame. In some implementations, the search area determination component 114 may define the first object search area as a geometric region, such as a circular or rectangular boundary, centered around the projected position parameter. In some implementations, the search area determination component 114 may adjust the size of the first object search area based on an estimated motion vector of the first object between the first and second frames. In some implementations, the search area determination component 114 may account for potential distortions in the video, such as those caused by wide-angle or spherical lenses, when determining the first object search area. In some implementations, the search area determination component 114 may incorporate temporal factors, such as the time elapsed between the first and second moments, to refine the boundaries of the first object search area.

The candidate object identification component 116 may be configured to determine sets of candidate objects in present in the object search areas in subsequent frames (e.g., the second frame, the third frame, and so on). For example, a first set of candidate objects present in the first object search area in the second frame may be determined. The first set of candidate objects may include a first candidate object. In some implementations, the candidate object identification component 116 may identify candidate objects based on their spatial alignment with the boundaries of the first object search area, which may be defined as a geometric region. In some implementations, the candidate object identification component 116 may detect candidate objects by analyzing pixel intensity variations, texture patterns, color gradients, and/or other parameters within the search area. In some implementations, the candidate object identification component 116 may determine the values of the apparent size parameter by evaluating the dimensions of bounding boxes that may encompass the candidate objects. In some implementations, the candidate object identification component 116 may determine the apparent size parameter by assessing the pixel density or area occupied by the candidate objects within the search area. Other techniques for determining the apparent size parameter are contemplated.

In some examples, the candidate object identification component 116 may be configured to determine a second set of candidate objects that may be present in the first object search area in the third frame. The second set of candidate objects may include a second candidate object, and determining, for individual ones of the candidate objects that may be detected in the first object search area in the third frame, values of the apparent size parameter. In some implementations, the candidate object identification component 116 may identify candidate objects by evaluating texture patterns or color gradients that may correspond to the visual characteristics of objects detected in prior frames.

Subsequent to batches of objects or candidate objects being detected by object detection component 110 and/or candidate object detection component 116, parameter determination component 112 may determine values for the individual objects and/or candidate objects of the apparent size parameter, the position parameter, and/or other parameters.

The object correlation component 120 may be configured to detect objects present in one of the frames, such as the first frame, within one or more subsequent frames (e.g., the second frame, the third frame, etc.) based on identifying a candidate object in a subsequent frame as a detected object in an earlier frame. For example, the object correlation component may be configured to identify the first object in the second frame by identifying the first candidate object as the first object in the second frame based on the values of the apparent size parameter determined for the candidate objects present in the first object search area in the second frame.

In some examples, the object correlation component 120 may be configured to identify the first candidate object as the first object in the second frame based on the value of the apparent size parameter determined for the first candidate object in the second frame being closer to the value of the apparent size parameter determined for the first object in the first frame than the value of the apparent size parameter determined for any other candidate object in the first set of candidate objects in the second frame. In some examples, the object correlation component 120 may be configured to identify the first candidate object as the first object in the second frame based on a difference between the value of the apparent size parameter determined for the first candidate object in the second frame and the value of the apparent size parameter determined for the first object in the first frame being less than a threshold difference. In some implementations, the object correlation component 120 may determine the threshold difference dynamically based on the resolution of the video frames being analyzed. In some implementations, the object correlation component 120 may adjust the threshold difference to account for potential scaling effects caused by changes in the object's distance from the camera. In some implementations, the object detection component 110 may incorporate additional metrics, such as the aspect ratio of the bounding box, to refine the identification process. The object correlation component 120 may identify the second candidate object as the first object in the third frame based on similar analysis with respect to the second set of candidate objects.

The trackable object indication component 118 may be configured to, responsive to detection of the first object in the second frame, the third frame, and/or other subsequent frames, visually indicate the first object as a trackable object during playback of the video at the first moment in the progress length. In some implementations, the trackable object indication component 118 may generate a highlighted bounding box around the first object to distinguish it from other objects at the first moment during playback. In some implementations, the trackable object indication component 118 may apply a color overlay or shading effect to the first object to enhance its visibility during playback. In some implementations, the trackable object indication component 118 may display a label or identifier, such as a numerical tag or descriptive text, adjacent to the first object to assist in its identification. In some implementations, the trackable object indication component 118 may adjust the opacity or brightness of the surrounding visual content to draw attention to the first object. In some implementations, the trackable object indication component 118 may incorporate an animation effect, such as a pulsing outline or dynamic resizing, to emphasize the first object during playback.

In some examples, the user input receiving component 124 may be configured to receive user input selecting the first object based on the visual indication. In some implementations, the user input receiving component 124 may interpret touch-based gestures on a touchscreen interface, such as tapping or dragging, to select the first object. In some implementations, the user input receiving component 124 may process voice commands that may specify the first object by name or description, such as “track the red car”. In some implementations, the user input receiving component 124 may detect input from a physical controller, such as a joystick or a mouse, to position a cursor over the first object for selection. In some implementations, the user input receiving component 124 may support gaze-tracking technology to allow a user to select the first object by focusing their visual attention on it during playback. In some implementations, the user input receiving component 124 may process multi-modal inputs, such as a combination of voice and touch, to confirm the selection of the first object.

In some examples, the framing determination component 126 may be configured to, and responsive to receipt of user selection of a trackable object, such as the first object, to determining a framing for the video that tracks the trackable object. In the example of the first object, the framing may present the video subsequent to the first moment in the progress length of the video. The framing may define a viewing window through which the visual content may be presented as a function of progress through the progress length of the video. The framing may specify an orientation parameter of the viewing window as a function of progress through the video to maintain the trackable object (e.g., the first object) within the viewing window. In some implementations, the framing determination component 126 may determine the dimensions of the viewing window based on the apparent size parameter of the first object such that the object may remain fully visible as it moves relative to other visual content within the video. In some implementations, the framing determination component 126 may adjust the aspect ratio, the level of zoom, and/or other parameters of the viewing window to accommodate changes in the spatial arrangement of the visual content.

In some implementations, the framing determination component 126 may determine the orientation parameter by referencing the position parameter of the trackable object in sequential frames to track its movement. In some implementations, the framing determination component 126 may adjust the orientation parameter to account for rotational shifts in the video content, such as yaw or pitch changes, to maintain alignment with the trackable object. In some implementations, the framing determination component 126 may incorporate predictive modeling to estimate the future trajectory of the trackable object and preemptively adjust the orientation parameter.

In some implementations, computing platform(s) 102, remote platform(s) 104, and/or external resources 128 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 128 may be operatively linked via some other communication media.

A given remote platform may include one or more processors configured to execute computer program components. The computer program components may be configured to enable an expert or user associated with the given remote platform to interface with system 100 and/or external resources 128, and/or provide other functionality attributed herein to remote platform(s) 104. By way of non-limiting example, a given remote platform and/or a given computing platform may include one or more of a smart card, a server, a desktop computer, a laptop computer, a handheld computer, a tablet computing platform, a NetBook, a Smartphone, a gaming console, and/or other computing platforms. In some implementations, the computing platform(s) 102 may comprise server(s), and the remote platform(s) 104 may comprise remotely located client computing platform(s).

External resources 128 may include sources of information outside of system 100, external entities participating with system 100, and/or other resources. In some implementations, some or all of the functionality attributed herein to external resources 128 may be provided by resources included in system 100.

Computing platform(s) 102 may include electronic storage 130, one or more processors 132, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 130 may comprise non-transitory storage media that electronically stores information. The electronic storage media of electronic storage 130 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from computing platform(s) 102, information received from remote platform(s) 104, and/or other information that enables computing platform(s) 102 to function as described herein.

Processor(s) 132 may be configured to provide information processing capabilities in computing platform(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute components 108, 110, 112, 114, 116, 118, 120, 124, 126, and/or other components by software; hardware; firmware; some combination of software, hardware, and/or firmware; and/or other mechanisms for configuring processing capabilities on processor(s) 132. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 124, and/or 126 are illustrated in FIG. 1 as being implemented within a single processing unit, in implementations in which processor(s) 132 includes multiple processing units, one or more of components 108, 110, 112, 114, 116, 118, 120, 124, and/or 126 may be implemented remotely from the other components. The description of the functionality provided by the different components 108, 110, 112, 114, 116, 118, 120, 124, and/or 126 described below is for illustrative purposes, and is not intended to be limiting, as any of components 108, 110, 112, 114, 116, 118, 120, 124, and/or 126 may provide more or less functionality than is described. For example, one or more of components 108, 110, 112, 114, 116, 118, 120, 124, and/or 126 may be eliminated, and some or all of its functionality may be provided by other ones of components 108, 110, 112, 114, 116, 118, 120, 124, and/or 126. As another example, processor(s) 132 may be configured to execute one or more additional components that may perform some or all of the functionality attributed below to one of components 108, 110, 112, 114, 116, 118, 120, 124, and/or 126.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

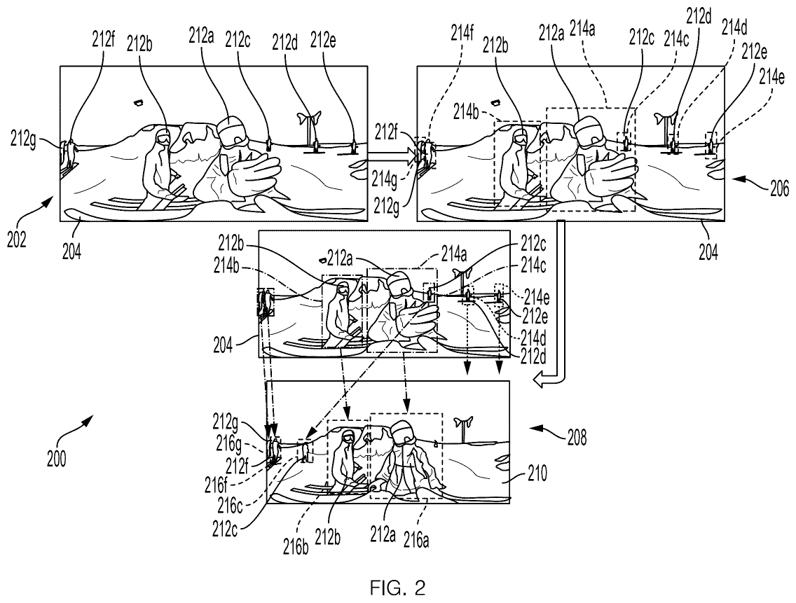

FIG. 2 may illustrate a diagram 200 of a process for facilitating user-selection of trackable objects portrayed in a video. The diagram 200 may depict the process across multiple operational stages, which may include a first stage 202, a second stage 206, and a third stage 208.

The first stage 202 may illustrate a first frame 204 of the video. The video may have a progress length, and the first frame 204 may correspond to a first moment along the progress length. As may be shown in the first stage 202, the system may obtain video information defining the first frame 204 and may detect a set of one or more objects present therein. In some examples, the set of objects detected in the first frame 204 may include a first object 212a, a second object 212b, a third object 212c, a fourth object 212d, a fifth object 212e, a sixth object 212f, and a seventh object 212g. These objects may be depicted in various poses and/or positions within the visual content of the first frame 204.

The second stage 206 may illustrate the processing of the first frame 204 to determine parameters for the detected objects. The system may determine, for individual ones of the set of objects (212a-212g) detected in the first frame 204, values of an apparent size parameter and a position parameter. The apparent size parameter may quantify the apparent sizes of the objects in the video, and the position parameter may specify its position within the visual content. In the second stage 206, these determinations may be represented by a first set of bounding boxes overlaying the objects: bounding box 214a for the first object 212a, bounding box 214b for the second object 212b, bounding box 214c for the third object 212c, bounding box 214d for the fourth object 212d, bounding box 214e for the fifth object 212e, bounding box 214f for the sixth object 212f, and bounding box 214g for the seventh object 212g. The dimensions of these bounding boxes 214a-214g may correspond to the determined values of the apparent size parameter, while the coordinates of the boxes may correspond to the determined values of the position parameter.

The third stage 208 may illustrate the validation of these objects against a second frame 210 of the video. The second frame 210 may correspond to a second moment in the progress length of the video that may be subsequent to the first moment. The second frame 210 may be non-adjacent to the first frame 204 in the progress length (e.g., they may be separated by a sampling interval). The third stage 208 may depict the first frame 204 (with bounding boxes 214a-214g) in vertical alignment with the second frame 210 to illustrate the determination of object persistence.

Due to natural activity and/or motion occurring between the first moment and the second moment, the objects in the second frame 210 may be in different poses or positions, or may no longer be present. As may be shown in the second frame 210, the first object 212a, second object 212b, third object 212c, sixth object 212f, and seventh object 212g may remain present. However, the fourth object 212d and fifth object 212e may not be present in the second frame 210 (e.g., they may have moved out of the field of view or may be occluded).

The system may determine a first object search area in the second frame 210 based on the values of the position parameters determined in the first frame 204. Within these search areas, the system may detect candidate objects and/or may determine values for the apparent size parameter and/or position parameter for said candidates. This may be represented in the third stage 208 by a second set of bounding boxes in the second frame 210: bounding box 216a for the first object 212a, bounding box 216b for the second object 212b, bounding box 216c for the third object 212c, bounding box 216f for the sixth object 212f, and bounding box 216g for the seventh object 212g. Notably, object 212c may have moved farthest from its original position, which may result in a significant shift between bounding box 214c and bounding box 216c.

As may be illustrated by the vertical correspondence lines in the third stage 208, the system may identify specific candidate objects in the second frame 210 as matching the original objects based on the values of the apparent size parameter (e.g., comparing dimensions of 214a to 216a). Correspondences may be established between 214a and 216a; 214b and 216b; 214c and 216c; 214f and 216f; and 214g and 216g. On the basis of these correspondences (and/or the absence of correspondences for objects 212d and 212e), the system may determine that the first object 212a, second object 212b, third object 212c, sixth object 212f, and seventh object 212g may be trackable objects.

Responsive to the detection of these objects in the second frame 210, the system may provide a visual indication that objects 212a, 212b, 212c, 212f, and 212g may be trackable. This visual indication may be presented during playback of the video at the first moment in the progress length, which may allow the user to select one of these verified objects for tracking. Conversely, because no corresponding candidate objects may have been detected for the fourth object 212d or fifth object 212e in the second frame 210 (or within the requisite search area), the system may forgo providing a visual indication for these objects, thereby potentially preventing the selection of untrackable items.

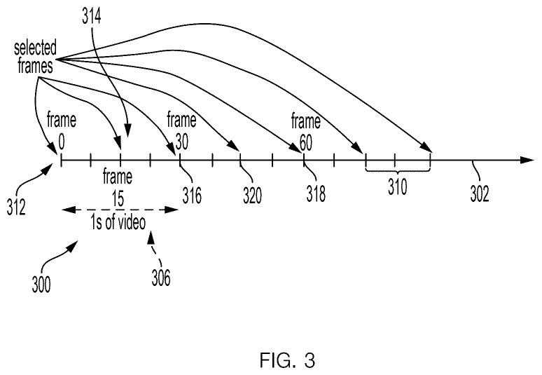

FIG. 3 may illustrate a diagram 300 depicting a temporal sampling scheme for determining trackability of objects in a video. The diagram 300 may include a progress timeline 302 that may represent the progress length of the video. The progress timeline 302 may be divided into a plurality of frame intervals, where individual frame intervals may correspond to the native frame rate of the video (e.g., 30 frames per second). As may be indicated by a time marker 306, a duration of one second may correspond to thirty individual frames along the progress timeline 302.

To efficiently facilitate user-selection of trackable objects without analyzing every frame, the system may implement a sampling rate (or detection rate) that may be lower than the native frame rate of the video. The diagram 300 may illustrate a selection of a set of candidate frames based on a sampling interval. The sampling interval may be determined based on a ratio of the video frame rate to a target detection rate. For example, if the video frame rate is 30 frames per second (fps) and the target detection rate is 2 fps, the sampling interval may be determined to be 15 frames, however, other sampling rates are contemplated.

Accordingly, the set of candidate frames may include an initial frame 312 (labeled Frame 0), which may correspond to the first moment in the progress length described herein, or the progress timeline 300 may not depict other moments in the progress length prior to the initial frame 312. Instead of analyzing the immediately adjacent frame (e.g., Frame 1), the system may skip the intervening frames defined by the sampling interval 310 to select a first sample frame 314 (labeled Frame 15). The first sample frame 314 may correspond to the second moment in the progress length described herein, wherein the second moment is non-adjacent to the first moment.

This pattern may continue along the progress timeline 302 to verify the persistence of objects over time. For example, the system may select a second sample frame 316 (labeled Frame 30) and a third sample frame 318 (labeled Frame 60). In some implementations, intermediate sample frames, such as indicated by the marker 320 (e.g., at Frame 45), may also be included in the set of candidate frames. By performing object detection and apparent size parameter comparison only on the frames indicated by the set of candidate frames, the system may validate the trackability of an object over a significant duration of the video while reducing and/or managing computational load.

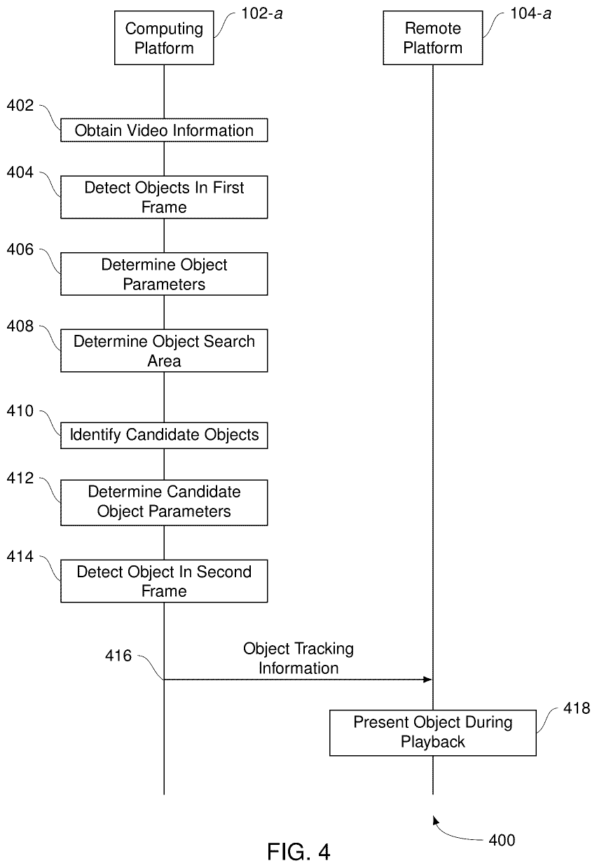

FIG. 4 illustrates an example of a process flow 400 for facilitating user selection of trackable objects in video content in accordance with aspects of the present disclosure. In some examples, the process flow 400 may implement aspects of the system 100. For example, the process flow 400 may include a computing platform 102-a (e.g., a server) and a remote platform 104-a (e.g., a user device), which may be examples of corresponding devices described herein. In some implementations, a computing platform 102-a facilitates user-selection of trackable objects portrayed in a video by detecting objects in frames, determining object parameters, identifying candidate objects across non-adjacent frames, and visually indicating trackable objects during video playback, while a remote platform 104-a enables user interaction with the video and trackable objects.

At 402, the computing platform 102-a may obtain video information defining the video. The video has a progress length. The video may include a sequence of frames portraying visual content as a function of progress through the progress length such that individual ones of the frames correspond with individual moments along the progress length. The frames including a first frame that corresponds to a first moment along the progress length. For example, the video information may include metadata specifying the frame rate, resolution, encoding format of the video, and/or other information. In some implementations, the video may be spherical, hemi-spherical, panoramic, and/or in some other wide angle format. The computing platform 102-a may store the video information in memory, which may include RAM, flash storage, or other storage media.

At 404, the computing platform 102-a may detect a set of one or more objects that may be present in the first frame, wherein the set of one or more objects may include a first object. For example, the computing platform 102-a may apply semantic filtering to the detected objects, which may involve determining classifications such as person, animal, or vehicle and retaining objects that may match predefined classifications. In some implementations, the computing platform 102-a may apply size filtering to exclude objects whose apparent size parameter may not meet a specified threshold, such as objects with bounding boxes smaller than a defined dimension. The computing platform 102-a may detect objects in various poses or positions within the visual content of the first frame, which may include stationary or moving objects.

At 406, the computing platform 102-a may determine, for individual ones of the one or more objects detected in the first frame, values of an apparent size parameter and a position parameter. The apparent size parameter may quantify apparent sizes of objects in the video and/or the position parameter may specify position within the visual content. For example, the computing platform 102-a may determine the apparent size parameter by measuring the dimensions of a bounding box encompassing the object in the first frame. In some implementations, the position parameter may be determined as the geometric center of the bounding box or as a directional vector relative to a reference frame. The computing platform 102-a may store these parameters in memory for subsequent analysis or comparison with other frames.

At 408, the computing platform 102-a may determine, based on a value of the position parameter determined for the first object in the first frame, a first object search area in a second frame corresponding to a second moment in the progress length of the video, wherein the second moment may be after the first moment, and wherein the second frame may not be adjacent to the first frame in the progress length of the video. For example, the computing platform 102-a may project the position parameter of the first object from the first frame into the second frame by defining a geometric region around the expected location of the object. In some implementations, the first object search area may be defined as a circular or rectangular region centered on the projected position, with dimensions that may account for potential movement or scaling of the object between frames. The computing platform 102-a may adjust the size of the search area dynamically based on the apparent size parameter of the object in the first frame to account for variations in object size across frames.

At 410, the computing platform 102-a may determine a first set of candidate objects that may be present in the first object search area in the second frame. The first set of candidate objects may include a first candidate object. For example, the computing platform 102-a may identify candidate objects within the search area by detecting objects whose position parameters may fall within the defined geometric boundaries of the search area. The computing platform 102-a may further refine the first set of candidate objects by applying semantic classifications, such as identifying whether the candidate objects may belong to predefined categories like person, animal, or vehicle.

At 412, the computing platform 102-a may determine, for individual ones of the candidate objects detected in the first object search area in the second frame, values of the apparent size parameter. For example, the computing platform 102-a may determine the values of the apparent size parameter by measuring the dimensions of bounding boxes encompassing the candidate objects in the second frame. In some implementations, the computing platform 102-a may determine the value of the apparent size parameter based on the pixel density or area occupied by the candidate object within the search area. The computing platform 102-a may further determine the value of the apparent size parameter by comparing the candidate object's silhouette or contour dimensions to predefined size metrics stored in memory.

At 414, the computing platform 102-a may detect the first object in the second frame by identifying the first candidate object as the first object in the second frame based on the values of the apparent size parameter that may be determined for the candidate objects. For example, the computing platform 102-a may compare the value of the apparent size parameter of the first candidate object to the value of the apparent size parameter of the first object in the first frame and may select the candidate object with the closest match. In some implementations, the computing platform 102-a may apply a threshold difference to the value of the apparent size parameter, where the first candidate object may be identified as the first object if the difference between the values of the apparent size parameter fall below the threshold. In other implementations, the computing platform 102-a may prioritize candidate objects based on a ranking system that may consider both the value of the apparent size parameter and the proximity of the candidate object to the projected position of the first object, as indicated by the values of the position parameters.

At 416, the computing platform 102-a may transmit information indicating the first object as a trackable object to the remote platform 104-a. For example, the computing platform 102-a may transmit metadata associated with the first object, such as its values of the apparent size parameter and the position parameter, to the remote platform 104-a to support further processing. In some implementations, the computing platform 102-a may include a visual indication of the first object within the transmitted information, such as a bounding box or highlight overlay, to assist the remote platform 104-a in identifying the object. The transmitted information may include a unique identifier for the first object, which may allow the remote platform 104-a to correlate the object with additional data or actions.

At 418, the remote platform 104-a may visually present the first object as a trackable object during playback of the video at the first moment in the progress length. For example, the remote platform 104-a may display a bounding box or highlight overlay around the first object to indicate its trackable status. In some implementations, the remote platform 104-a may use a distinct color or animation effect, such as a pulsing outline, to differentiate the first object from other objects in the visual content. The remote platform 104-a may present an icon or label near the first object to signify its classification, such as “person” or “vehicle”, based on semantic filtering performed earlier.

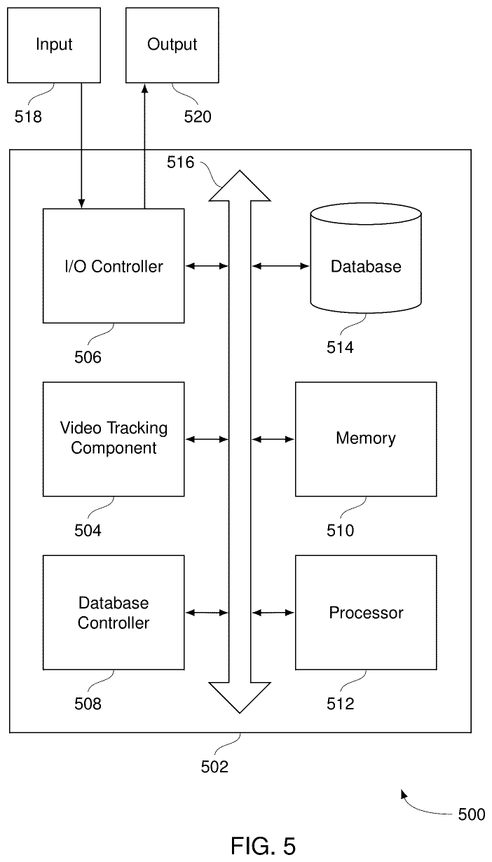

FIG. 5 shows a diagram of a system 500 including a device 502 configured for facilitating user selection of trackable objects in video content in accordance with aspects of the present disclosure. The device 502 may be an example of or include the components of a computing platform 102 and a remote platform 104 as described herein. The device 502 may include components for bi-directional data communications including components for transmitting and receiving communications, including a video tracking component 504, an I/O controller 506, a database controller 508, memory 510, a processor 512, and a database 514. These components may be in electronic communication via one or more buses (e.g., bus 516).

The video tracking component 504 may be an example of one or more components of the system 100 as described herein. For example, the video tracking component 504 may perform any of the methods or processes described above with reference to machine-readable instructions 106 in connection with FIG. 1. In some cases, the video tracking component 504 may be implemented in hardware, software executed by a processor, firmware, or any combination thereof.

The I/O controller 506 may manage input signals 518 and output signals 520 for the device 502. The I/O controller 506 may also manage peripherals not integrated into the device 502. In some cases, the I/O controller 506 may represent a physical connection or port to an external peripheral. In some cases, the I/O controller 506 may utilize an operating system such as iOS®, ANDROID®, MS-DOS®, MS-WINDOWS®, OS/2®, UNIX®, LINUX®, or another known operating system. In other cases, the I/O controller 506 may represent or interact with a modem, a keyboard, a mouse, a touchscreen, or a similar device. In some cases, the I/O controller 506 may be implemented as part of a processor. In some cases, a user may interact with the device 502 via the I/O controller 506 or via hardware components controlled by the I/O controller 506.

The database controller 508 may manage data storage and processing in a database 514. In some cases, a user may interact with the database controller 508. In other cases, the database controller 508 may operate automatically without user interaction. The database 514 may be an example of a single database, a distributed database, multiple distributed databases, a data store, a data lake, or an emergency backup database.

Memory 510 may include random-access memory (RAM) and read-only memory (ROM). The memory 510 may store computer-readable, computer-executable software including instructions that, when executed, cause the processor to perform various functions described herein. In some cases, the memory 510 may contain, among other things, a basic input/output system (BIOS) which may control basic hardware or software operation such as the interaction with peripheral components or devices.

The processor 512 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 512 may be configured to operate a memory array using a memory controller. In other cases, a memory controller may be integrated into the processor 512. The processor 512 may be configured to execute computer-readable instructions stored in a memory 510 to perform various functions (e.g., functions or tasks for facilitating user selection of trackable objects in video content).

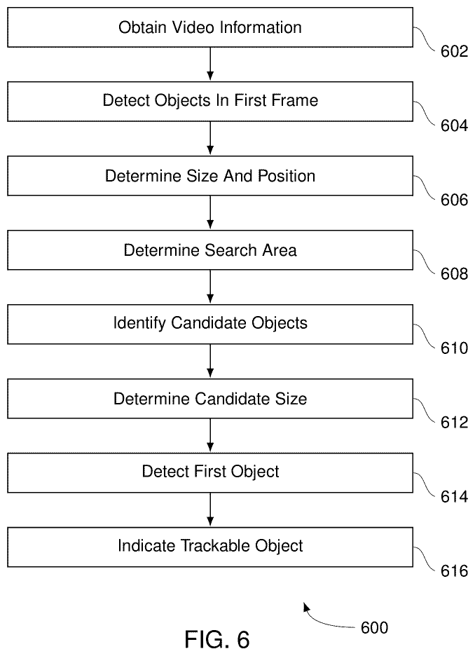

FIG. 6 shows a flowchart illustrating a method 600 for facilitating user selection of trackable objects in video content in accordance with various aspects of the present disclosure. The operations of the method 600 may be implemented by one or more components of a networked computing system as described herein. For example, the operations of the method 600 may be performed by video tracking component 504 or through execution of machine-readable instructions 106 as described with reference to FIG. 5 and FIG. 1, respectively. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 602, the method 600 may include obtaining video information defining the video, the video having a progress length, the video including a sequence of frames portraying visual content as a function of progress through the progress length such that individual ones of the frames correspond with individual moments along the progress length, the frames including a first frame that corresponds to a first moment along the progress length. The operations of 602 may be performed in accordance with examples as disclosed herein. In some examples, aspects of the operations of 602 may be performed by a video information obtaining component 108 as described with reference to FIG. 1.

At 604, the method 600 may include detecting a set of one or more objects present in the first frame, wherein the set of one or more objects includes a first object. The operations of 604 may be performed in accordance with examples as disclosed herein. In some examples, aspects of the operations of 604 may be performed by an object detection component 110 as described with reference to FIG. 1.

At 606, the method 600 may include determining, for individual ones of the one or more objects detected in the first frame, values of an apparent size parameter and a position parameter, wherein the apparent size parameter quantifies apparent sizes of objects in the video and the position parameter specifies position within the visual content. The operations of 606 may be performed in accordance with examples as disclosed herein. In some examples, aspects of the operations of 606 may be performed by a parameter determination component 112 as described with reference to FIG. 1.

At 608, the method 600 may include determining, based on a value of the position parameter determined for the first object in the first frame, a first object search area in a second frame corresponding to a second moment in the progress length of the video, wherein the second moment is after the first moment, and wherein the second frame is not adjacent to the first frame in the progress length of the video. The operations of 608 may be performed in accordance with examples as disclosed herein. In some examples, aspects of the operations of 608 may be performed by a search area determination component 114 as described with reference to FIG. 1.

At 610, the method 600 may include determining a first set of candidate objects present in the first object search area in the second frame, wherein the first set of candidate objects includes a first candidate object. The operations of 610 may be performed in accordance with examples as disclosed herein. In some examples, aspects of the operations of 610 may be performed by a candidate object identification component 116 as described with reference to FIG. 1.

At 612, the method 600 may include determining, for individual ones of the candidate objects detected in the first object search area in the second frame, values of the apparent size parameter. The operations of 612 may be performed in accordance with examples as disclosed herein. In some examples, aspects of the operations of 612 may be performed by a parameter determination component 112 as described with reference to FIG. 1.

At 614, the method 600 may include detecting the first object in the second frame by identifying the first candidate object as the first object in the second frame based on the values of the apparent size parameter determined for the candidate objects. The operations of 614 may be performed in accordance with examples as disclosed herein. In some examples, aspects of the operations of 614 may be performed by a size-based filtering component 122 as described with reference to FIG. 1.

At 616, the method 600 may include, responsive to detection of the first object in the second frame, visually indicating the first object as a trackable object during playback of the video at the first moment in the progress length. The operations of 616 may be performed in accordance with examples as disclosed herein. In some examples, aspects of the operations of 616 may be performed by a trackable object indication component 118 as described with reference to FIG. 1.

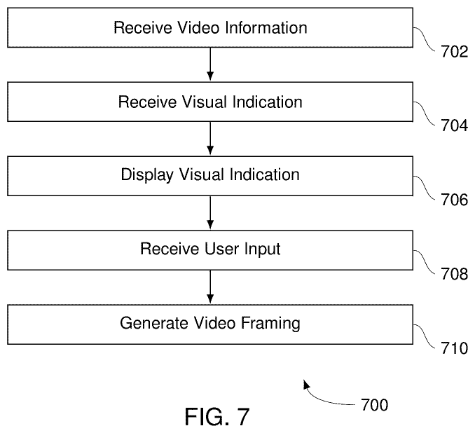

FIG. 7 shows a flowchart illustrating a method 700 for facilitating user selection of trackable objects in video content in accordance with various aspects of the present disclosure. The operations of the method 700 may be implemented by one or more components of a networked computing system as described herein. For example, the operations of the method 700 may be performed by video tracking component 504 or through execution of machine-readable instructions 106 as described with reference to FIG. 5 and FIG. 1, respectively. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 702, the method 700 may include receiving, by a user device, video information defining the video, the video having a progress length, the video including a sequence of frames portraying visual content as a function of progress through the progress length such that individual ones of the frames correspond with individual moments along the progress length, the frames including a first frame that corresponds to a first moment along the progress length. The operations of 702 may be performed in accordance with examples as disclosed herein. In some examples, aspects of the operations of 702 may be performed by a video information obtaining component 108 as described with reference to FIG. 1.

At 704, the method 700 may include receiving, by the user device, a visual indication of a set of one or more objects present in the first frame, wherein the set of one or more objects includes a first object, the visual indication being based on a determination that the first object is trackable. The operations of 704 may be performed in accordance with examples as disclosed herein. In some examples, aspects of the operations of 704 may be performed by an object detection component 110 as described with reference to FIG. 1.

At 706, the method 700 may include displaying, by the user device, the visual indication of the first object as a trackable object during playback of the video at the first moment in the progress length. The operations of 706 may be performed in accordance with examples as disclosed herein. In some examples, aspects of the operations of 706 may be performed by a trackable object indication component 118 as described with reference to FIG. 1.

At 708, the method 700 may include receiving, by the user device, user input selecting the first object based on the visual indication. The operations of 708 may be performed in accordance with examples as disclosed herein. In some examples, aspects of the operations of 708 may be performed by a user input receiving component 124 as described with reference to FIG. 1.

At 710, the method 700 may include, responsive to the user input, generating, by the user device, a framing for the video, the framing specifying a viewing window and an orientation parameter as a function of progress through the video to maintain the first object within the viewing window. The operations of 710 may be performed in accordance with examples as disclosed herein. In some examples, aspects of the operations of 710 may be performed by a framing determination component 126 as described with reference to FIG. 1.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A system configured for facilitating user-selection of trackable objects portrayed in a video, comprising:
a processor;
memory coupled with the processor; and
instructions stored in the memory and executable by the processor to cause the system to:
obtain video information defining the video, the video having a progress length, the video including a sequence of frames portraying visual content as a function of progress through the progress length such that individual ones of the frames correspond with individual moments along the progress length, the frames including a first frame that corresponds to a first moment along the progress length;
detect a set of one or more objects present in the first frame, wherein the set of one or more objects includes a first object;
determine, for individual ones of the one or more objects detected in the first frame, values of an apparent size parameter and a position parameter, wherein the apparent size parameter quantifies apparent sizes of objects in the video and the position parameter specifies position within the visual content;
determine, based on a value of the position parameter determined for the first object in the first frame, a first object search area in a second frame corresponding to a second moment in the progress length of the video, wherein the second moment is after the first moment, and wherein the second frame is not adjacent to the first frame in the progress length of the video;
determine a first set of candidate objects present in the first object search area in the second frame, wherein the first set of candidate objects includes a first candidate object, and wherein determining the first set of candidate objects includes:
detecting candidate objects present in the second frame, wherein the candidate objects include the first candidate object;
determining, for individual ones of the candidate objects detected in the second frame, values of the position parameter; and
determining the first set of candidate objects present in the first object search area in the second frame based on the values of the position parameter determined for the candidate objects in the second frame and the first object search area in the second frame;
determine, for individual ones of the candidate objects detected in the first object search area in the second frame, values of the apparent size parameter;
detect the first object in the second frame by identifying the first candidate object as the first object in the second frame based on the values of the apparent size parameter determined for the candidate objects;
responsive to detection of the first object in the second frame, visually indicate the first object as a trackable object during playback of the video at the first moment in the progress length;
receive user input selecting the first object based on the visual indication;
responsive to the selection, determine a framing for the video that tracks the first object subsequent to the first moment in the progress length of the video; and
playback the video using the framing that tracks the first object subsequent to the first moment in the progress length of the video.

2. The system of claim 1, wherein the sequence of frames includes between 10 and 45 frames that correspond to moments in the progress length of the video between the first moment and the second moment.

3. A system configured for facilitating user-selection of trackable objects portrayed in a video, comprising:
a processor;
memory coupled with the processor; and
instructions stored in the memory and executable by the processor to cause the system to:
obtain video information defining the video, the video having a progress length, the video including a sequence of frames portraying visual content as a function of progress through the progress length such that individual ones of the frames correspond with individual moments along the progress length, the frames including a first frame that corresponds to a first moment along the progress length;
detect a set of one or more objects present in the first frame, wherein the set of one or more objects includes a first object;
determine, for individual ones of the one or more objects detected in the first frame, values of an apparent size parameter and a position parameter, wherein the apparent size parameter quantifies apparent sizes of objects in the video and the position parameter specifies position within the visual content;
determine, based on a value of the position parameter determined for the first object in the first frame, a first object search area in a second frame corresponding to a second moment in the progress length of the video, wherein the second moment is after the first moment, and wherein the second frame is not adjacent to the first frame in the progress length of the video;
determine a first set of candidate objects present in the first object search area in the second frame, wherein the first set of candidate objects includes a first candidate object;
determine, for individual ones of the first set of candidate objects detected in the first object search area in the second frame, values of the apparent size parameter;
detect the first object in the second frame by identifying the first candidate object as the first object in the second frame based on the values of the apparent size parameter determined for the first set of candidate objects; and
responsive to detection of the first object in the second frame, visually indicate the first object as a trackable object during playback of the video at the first moment in the progress length.

4. The system of claim 3, wherein detecting the set of one or more objects present in the first frame includes:
detecting potential objects present in the first frame;
determining semantic classifications for the potential objects present in the first frame, such that a first semantic classification is determined for the first object;
filtering the potential objects based on the semantic classifications for the potential objects such that inclusion of the first object in the set of objects present in the first frame is based on determination of the first semantic classification for the first object.

5. The system of claim 3, wherein detecting the set of one or more objects present in the first frame includes:
detecting potential objects present in the first frame;
filtering the potential objects based on values of the apparent size parameter of the potential objects in the first frame such that inclusion of the first object in the set of objects present in the first frame is based on the value of the apparent size parameter of the first object in the first frame satisfying a minimum size threshold.

6. The system of claim 3, further comprising:
responsive to detection of the first object in the second frame, determining, based on the value of the position parameter determined for the first candidate object in the second frame, a first object search area in a third frame corresponding to a third moment in the progress length of the video, wherein the third moment is after the second moment, and wherein the third frame is not adjacent to the second frame in the progress length of the video;
determining a second set of candidate objects present in the first object search area in the third frame, wherein the second set of candidate objects includes a second candidate object;
determining, for individual ones of the second set of candidate objects detected in the first object search area in the third frame, values of the apparent size parameter; and
detecting the first object in the third frame by identifying the second candidate object as the first object in the third frame based on the values of the apparent size parameter determined for the second set of candidate objects, and
wherein visually indicating the first object as a trackable object during playback of the video at the first moment in the progress length is further responsive to detection of the first object in the third frame.

7. The system of claim 3, wherein the sequence of frames includes at least one frame corresponding to a moment in the progress length of the video prior to the first moment.

8. The system of claim 3, wherein the sequence of frames includes between 10 and 45 frames that correspond to moments in the progress length of the video between the first moment and the second moment.

9. The system of claim 3, wherein determining the first set of candidate objects includes:
detecting candidate objects present in the second frame, wherein the candidate objects include the first candidate object;
determining, for individual ones of the candidate objects detected in the second frame, values of the position parameter; and
determining the first set of candidate objects present in the first object search area in the second frame based on the values of the position parameter determined for the candidate objects in the second frame and the first object search area in the second frame.

10. The system of claim 3, further comprising receiving user input selecting the first object based on the visual indication, and responsive to said selection, determining a framing for the video that tracks the first object subsequent to the first moment in the progress length of the video.

11. The system of claim 10, wherein the framing specifies a viewing window through which the visual content is presented as a function of progress through the progress length of the video, and wherein the framing specifies an orientation parameter of the viewing window as a function of progress through the video to maintain the first object within the viewing window.

12. A method of facilitating user-selection of trackable objects portrayed in a video, the method comprising:
obtaining video information defining the video, the video having a progress length, the video including a sequence of frames portraying visual content as a function of progress through the progress length such that individual ones of the frames corresponding with individual moments along the progress length, the frames including a first frame that corresponds to a first moment along the progress length;
detecting a set of one or more objects present in the first frame, wherein the set of one or more objects includes a first object;
determining, for individual ones of the one or more objects detected in the first frame, values of an apparent size parameter and a position parameter, wherein the apparent size parameter quantifies apparent sizes of objects in the video and the position parameter specifies position within the visual content;
determining, based on a value of the position parameter determined for the first object in the first frame, a first object search area in a second frame corresponding to a second moment in the progress length of the video, wherein the second moment is after the first moment, and wherein the second frame is not adjacent to the first frame in the progress length of the video;
determining a first set of candidate objects present in the first object search area in the second frame, wherein the first set of candidate objects includes a first candidate object;
determining, for individual ones of the candidate objects detected in the first object search area in the second frame, values of the apparent size parameter;
detecting the first object in the second frame by identifying the first candidate object as the first object in the second frame based on the values of the apparent size parameter determined for the candidate objects;
responsive to detection of the first object in the second frame, visually indicating the first object as a trackable object during playback of the video at the first moment in the progress length.

13. The method of claim 12, wherein detecting the set of one or more objects present in the first frame includes:
detecting potential objects present in the first frame;
determining semantic classifications for the potential objects present in the first frame, such that a first semantic classification is determined for the first object;
filtering the potential objects based on the semantic classifications for the potential objects such that inclusion of the first object in the set of objects present in the first frame is based on determination of the first semantic classification for the first object.

14. The method of claim 12, wherein detecting the set of one or more objects present in the first frame includes:
detecting potential objects present in the first frame;
filtering the potential objects based on values of the apparent size parameter of the potential objects in the first frame such that inclusion of the first object in the set of objects present in the first frame is based on the value of the apparent size parameter of the first object in the first frame satisfying a minimum size threshold.

15. The method of claim 12, further comprising:
responsive to detection of the first object in the second frame, determining, based on the value of the position parameter determined for the first candidate object in the second frame, a first object search area in a third frame corresponding to a third moment in the progress length of the video, wherein the third moment is after the second moment, and wherein the third frame is not adjacent to the second frame in the progress length of the video;
determining a second set of candidate objects present in the first object search area in the third frame, wherein the second set of candidate objects includes a second candidate object;
determining, for individual ones of the candidate objects detected in the first object search area in the third frame, values of the apparent size parameter; and
detecting the first object in the third frame by identifying the second candidate object as the first object in the third frame based on the values of the apparent size parameter determined for the candidate objects, and
wherein visually indicating the first object as a trackable object during playback of the video at the first moment in the progress length is further responsive to detection of the first object in the third frame.

16. The method of claim 12, wherein the sequence of frames includes at least one frame corresponding to a moment in the progress length of the video prior to the first moment.

17. The method of claim 12, wherein the sequence of frames includes between 10 and 45 frames that correspond to moments in the progress length of the video between the first moment and the second moment.

18. The method of claim 12, wherein determining the first set of candidate objects includes:
detecting candidate objects present in the second frame, wherein the candidate objects include the first candidate object;
determining, for individual ones of the candidate objects detected in the second frame, values of the position parameter; and
determining the first set of candidate objects present in the first object search area in the second frame based on the values of the position parameter determined for the candidate objects in the second frame and the first object search area in the second frame.

19. The method of claim 12, further comprising receiving user input selecting the first object based on the visual indication, and responsive to said selection, determining a framing for the video that tracks the first object subsequent to the first moment in the progress length of the video, wherein the framing specifies a viewing window through which the visual content is presented as a function of progress through the progress length of the video.

20. The method of claim 19, wherein the framing specifies an orientation parameter of the viewing window as a function of progress through the video to maintain the first object within the viewing window.
